(19) United States
(12) Patent Application Publication
(10) Pub. No.: US 2016/0147657 A1
(43) Pub. Date: May 26, 2016

(54) SYSTEM AND METHOD FOR OPTIMIZED DISK IO RAM CACHING FOR A VDI ENVIRONMENT

(71) Applicant: Dell Products L.P., Round Rock, TX (US)

(72) Inventors: Yinglong Jiang, Murroe (IE); John Kelly, Dooradoyle (IE)

(21) Appl. No.: 14/550,712

(22) Filed: Nov. 21, 2014

(51) Int. Cl. G06F 12/08; G06F 9/455

(52) U.S. Cl. CPC G06F 12/0806; G06F 9/45558; G06F 2212/657; G06F 2009/45583

(57) ABSTRACT

A system and method provides optimized caching to RAM of disk input/output operations in a virtual environment, such as a virtual desktop infrastructure environment (VDI), thereby reducing the I/O operations per second (IOPS). Generally, existing technologies allocate a fixed amount of RAM for caching based on static criteria and do not consider the actual RAM utilization at a particular point in time. The system and method provides a mechanism for lowering the costs associated with TOPS by utilizing relevant assessment techniques to determine actual RAM usage. The system and method provides an information handling system to dynamically allocate cache so as to optimize the allocation of RAM to cache for use by I/O operations in any virtual environment, for example, a VDI environment. By providing a dynamic allocation the disk requirements for implementing a VDI environment may be reduced.

### FIELD OF THE DISCLOSURE

This disclosure relates generally to information handling systems, and more particularly relates to optimizing the caching to RAM of disk input/output (I/O) operations in a virtual environment, such as a virtual desktop infrastructure (VDI) environment, thereby reducing disk I/O operations per second (IOPS).

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. A virtual environment, such as a virtual desktop infrastructure (VDI), separates a desktop environment and its associated software in a data center, from the information handling system that is used to access the desktop environment.

The consolidated nature of a VDI environment produces significant disk Input/Output operations per second (IOPS) requirements in an information handling system. This results in the information handling system requiring large amounts of storage devices, for example, hard-disk drive storage, to deliver the required TOPS. As the amount of required storage space increases, so does the overall cost of developing and implementing the VDI solution. Such costs may be significantly greater than the costs associated with a similar physical information handling system, for example, a PC. The costs associated with complying with the storage space requirements may be a barrier to the adoption of VDI environments. The present invention overcomes this barrier by optimizing the memory usage by cache by ensuring that all memory that is not required for other purposes may be used for cache.

### SUMMARY

In accordance with the present disclosure, a system and method are herein disclosed for providing optimized caching to RAM of disk input/output (I/O) operations in a virtual environment, such as a virtual desktop infrastructure (VDI) environment, thereby reducing the I/O operations per second (IOPS). Generally, existing technologies allocate a fixed amount of RAM for caching based on static criteria and do not consider the actual RAM utilization at a particular point in time. The system and method disclosed herein are technically advantageous because a mechanism is provided for lowering the costs associated with TOPS. In particular, the present disclosure provides a way for an information handling system to dynamically allocate cache so as to optimize the caching to RAM of I/O operations in any virtual environment, for example, a VDI environment. By providing a dynamic allocation the disk requirements for implementing a VDI environment may be reduced. Other technical advantages will be apparent to those of ordinary skill in the art in view of the following specification, claims.

In an information handling system, it may be advantageous from a cost, administrative and security standpoint to implement a VDI environment. In one embodiment, a configuration activity of the information handling system sets the initial amount of RAM allocated for disk I/O caching. A relevant assessment technique may be performed to dynamically alter this allocation according to one or more factors associated with the technique. Relevant assessment techniques may allocate memory for caching based, at least in part, on: 1) the amount of memory, for example, RAM allocated for non-caching related activities as reported by the virtual machine manager such as a hypervisor; 2) utilization of virtualization specific technologies by re-allocating RAM that is actually unused though it may appear on a cursory inspection to be used; and 3) overriding RAM utilized by low priority user activities on the virtual desktop such as activities associated with games and music. A scheduled task or master activity may be executed to assess the allocation of RAM and re-allocate RAM to cache. The allocation of RAM to cache may be bound by upper and lower thresholds.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the present disclosure;

FIG. 2 is a flowchart of a method of an information handling system according to an embodiment of the present disclosure; and

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

This disclosure generally relates to implementation of a virtual environment in information handling systems and, in particular, relates to the optimization of the caching to RAM of I/O operations in the virtual environment, thereby reducing the IOPS requirements. One such virtual environment is a VDI environment. This disclosure contemplates any number of virtual environments as known to one of ordinary skill in the art. The system and method involve an information handling system that dynamically allocates the amount of RAM for caching, reducing the necessity to increase the amount of storage. In prior systems and methods, the non-volatile memory space may need to be enlarged by installing a device with a larger capacity or by installing multiple devices to accommodate the requirements of the information handling system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), system management RAM (SMRAM), one or more processing resources such as a central processing unit (CPU) or hardware or software control logic, ROM, and/or other types of nonvolatile memory. Additional components of the information handling system may include an interface to a virtual machine manager, an interface to a web console, an interface to a management console, a remote access controller, a hypervisor, one or more disk drives, one or more network ports for communication with external devices as well as various I/O devices, such as a keyboard, a mouse, and a video display. The information handling system may also include one or more buses operable to transmit communications between the various hardware components.

For the purposes of this disclosure, computer-readable storage media may include any instrumentality or aggregation of instrumentalities that may retain data and/or instructions for a period of time. Computer-readable storage media may include, for example, without limitation, storage media such as a direct access storage device (e.g., a hard disk drive or floppy disk), a sequential access storage device (e.g., a tape disk drive), compact disk, CD-ROM, DVD, RAM, ROM, electrically erasable programmable read-only memory (EEPROM), and/or flash memory.

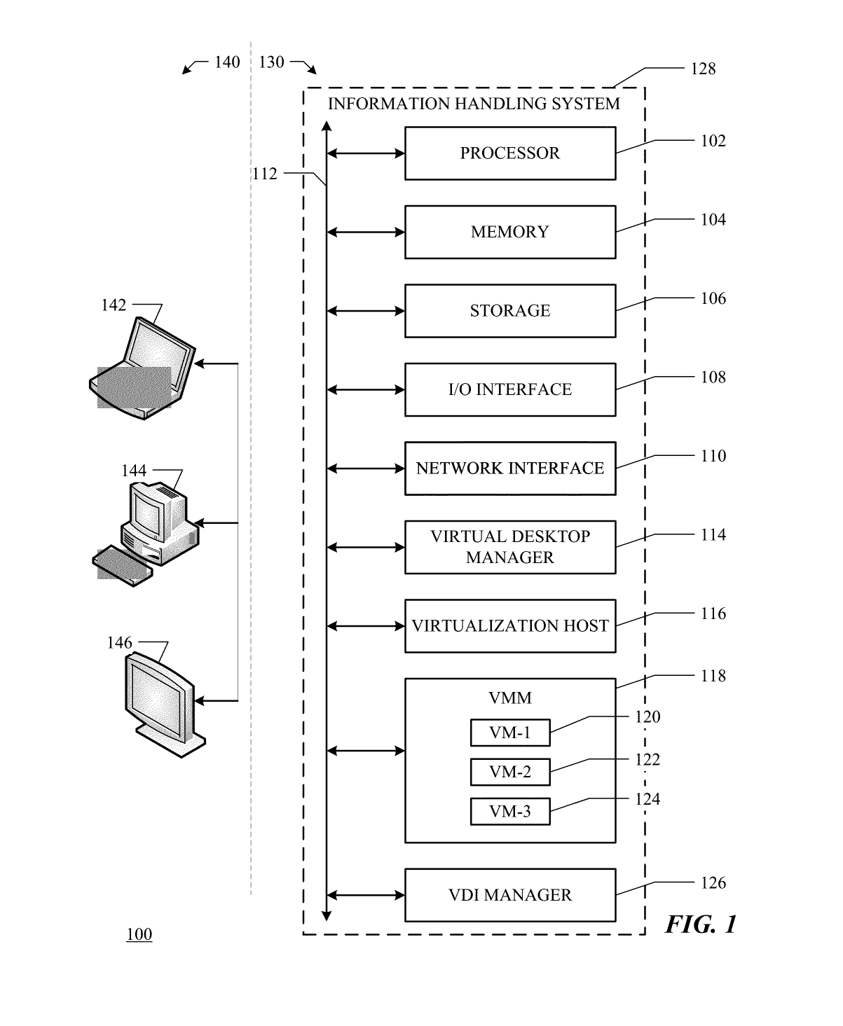

FIG. 1 illustrates a virtual desktop environment 100 that can be implemented on one or more information handling systems. For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An example of an information handling system includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

Virtual desktop environment 100 includes a user environment 140 and a virtual desktop infrastructure (VDI) 130. User environment 140 includes user systems 142, 144, and 146. User systems 142, 144, and 146 may be any type of information handling system known to one of ordinary skill in the art. For example, user systems 142, 144, and 146 may be laptop computers, PCs, thin-clients, smart monitors, tablets, phablets, or any other device known to one of ordinary skill in the art that can connect to a network as an endpoint for VDI 130. While three devices are shown as user systems 142, 144, and 146, one of ordinary skill in the art understands that user systems 142, 144, and 146 may be any number of suitable devices.

In one or more embodiments, VDI 130 includes an information handling system 128 capable of deploying virtual machines. Information handling system 128 may comprise any number of devices and may be any number of information handling systems suitable to implement the VDI 130 environment. Information handling system 128 includes a processor 102, memory 104, storage 106, an input/output (I/O) interface 108, a network interface 110, and a bus(es) 112. Although this disclosure describes and illustrates a particular information handling system 128 having a particular set of particular components in a particular arrangement, this disclosure contemplates any suitable information handling system having any suitable combination and arrangement of components as known to one of ordinary skill in the art. For example, virtualization host 126, virtual desktop manager 114, and VDI manager 126 may be implemented on information handling system 128 or may be implemented on any suitable combination of information handling systems.

Virtual desktop environment 100 operates to present a remotely operated and maintained operating system environment and application software to the user systems 142, 144, and 146. The virtual desktop manager 114 authenticates any user system that attempts to log on to the VDI 130 and also determines the operating system environment and application software needs of the authenticated user systems. The virtual desktop manager 114 instantiates a virtual machine associated with each authenticated user system. VDI manager 126 may be used to gather certain metrics associated with each of the authenticated user systems. For example, the VDI manager may use these metrics to determine if certain upgrades are necessary. VDI manager 126 may also determine if any of the hardware resources of virtualization host 116 are within any usage threshold limits. For example, the VDI manager 126 may determine if hardware and/or software resources of virtualization host 116, such as memory or disk storage capacity, processing capacity, I/O capacity, or other usages are within predetermined threshold limits. The VDI manager 126 may operate to provide any number of services and operations known to one of ordinary skill in the art. In certain embodiments, the VDI manager 126 may be any known manager required by a particular virtual desktop environment 100 and is not limited to a manager for a VDI environment.

In an example embodiment, processor 102 may include hardware and software components for the structure and operation of the process steps and system disclosed. While not specifically shown, it should be understood that any number of program modules comprising computer-readable instructions may be stored in the information handling system storage 106 or other memory and may be executed by processor 102. Upon execution of the computer-readable instructions, certain actions may be performed as described in this disclosure.

Storage 106 or memory 104 or other such memory may be a hard-disk drive, magnetic disk, optical disk, ROM, RAM or any other computer media known to one of ordinary skill in the art for the storage and retrieval of data, including executable or computer-readable instructions. A VDI 130 typically requires the sending and receiving of large amounts of data. Data may be stored in any one or more of storage 106 and memory 104. As is known to one of ordinary skill in the art, some storage mediums have faster data access times than other storage mediums. For example, long-term data or data that does not need to be accessed frequently or quickly may generally be stored on a hard-disk drive or other non-volatile storage medium, such as storage 106, known to one of ordinary skill in the art. Retrieving and storing data to storage 106 may increase the time to perform an I/O operation as access times are typically longer than performing I/O operations from a faster storage medium, for example, memory 104. The TOPS associated with performing I/O operations to a storage 106 may not meet the requirements necessary to implement efficiently VDI 130 and thus memory 104 must be used to ensure efficient access to data within VDI 130 where memory 104 resources allow.

In one embodiment, storage 106 is non-volatile long-term memory such as a hard-disk drive, magnetic disk, optical disk or any other storage device known to one of ordinary skill in the art. Storage 106 typically has a longer access time than memory 104. In one embodiment, memory 104 may be memory with reasonably fast access times, such as RAM. Memory 104 may be any memory known to one of ordinary skill in the art that provides efficient access to data, for example, RAM, suitable for use as cache for VDI 130. In this disclosure, RAM may be used interchangeable with memory 104 but is not intended to limit memory 104 to RAM only memory. In another embodiment, memory 104 includes main memory for storing instructions for processor 102 to execute or data for processor 102 to operate on. As an example, information handling system 128 may load instructions for execution from storage 106 or another source (such as, for example, another information handlings system 128, an external memory source, a remote memory source, or any other memory source known to one of ordinary skill in the art) to memory 104. Bus 112 may include one or more buses for connecting processor 102, memory 104, storage 106, I/O interface 108 and network interface 110.

In another embodiment, I/O interface 108 includes hardware, software, or both for providing one or more interfaces for communication between information handling system 128 and one or more I/O devices. Information handling system 128 may include one or more I/O devices, where appropriate. One or more of these I/O devices may enable communication between an individual or other software and information handling system 128. As an example, an I/O device may include a keyboard, keypad, microphone, monitor, mouse, or any other I/O device known to one of ordinary skill in the art or a combination of two or more I/O devices. For example, the I/O device may allow an individual or other software to request instantiation of a virtual application. I/O interface 108 may include one or more devices or software drivers enabling processor 102 to drive one or more of these I/O devices. I/O interface 108 may include one or more I/O interfaces 108, where appropriate. Although this disclosure describes and illustrates a particular I/O interface, the disclosure contemplates any suitable I/O interface.

In an example embodiment, network interface 110 includes firmware, hardware, software, or any combination thereof for providing one or more interfaces for communication (for example, packet-based communication) between information handling system 128 and one or more other information handling system 128 on one or more networks. For example, network interface 110 may include a network interface controller (NIC) or network adapter for communicating with a telephone network, an Ethernet or other wire-based network or a wireless NIC (WNIC) or wireless adapter for communicating with a wireless network, such as a WI-FI network, or any other network interface for communicating with any type of network known to one of ordinary skill in the art. In one embodiment, information handling system 128 may connect to user systems 142, 144, and 146 through a network via a wireless or wired connection using any protocol known to one of ordinary skill in the art.

In an example embodiment, bus 112 includes hardware, software, or both which couples components of information handling system 128 to each other. Bus 112 may include one or more buses where appropriate and may communicatively, physically, virtually, or otherwise as required couple the components of information handling system 128 to each other. Bus 112 may connect one or more information handling systems 128 to each other. For example, bus 112 may connect an information handling system hosting any combination of the virtualization host 116, VDI manager, virtual desktop manager 114, and VDI manager 126.

VDI 130 includes a virtual desktop manager 114, a virtualization host 116, and a VDI manager 126. Virtual desktop environment 100 operates to present a remotely operated and maintained operating system environment and application software to user systems 142, 144, and 146. In particular, when one of the user systems 142, 144, and 146 logs on to VDI 130, virtual desktop manager 114 authenticates the user, determines the operating system environment and application software needs of the user, and directs virtualization host 116 to instantiate a virtual machine that is associated with the user, and that runs the operating system environment and application software. Virtualization host 116 includes a virtual machine manager (VMM) 118 that operates to manage any instantiated virtual machine. For example, when a user system 142 connects to VDI 130, virtual desktop manager 114 directs virtualization host 116 to instantiate a virtual machine 120 associated with the user system 142. Similarly, for example, a virtual machine 122 is instantiated when user system 144 connects to VDI 130, and a virtual machine 124 is instantiated when user system 146 connects to VDI 130. As understood by one of ordinary skill in the art, VMM 118 may manage as many virtual machines as permitted by information handling system 128. In one embodiment, VMM 118 may be a hypervisor.

In a particular embodiment, two or more of virtual machines 120, 122, and 124 are instantiated with a configured cache size on the information handling system 128 where the cache is an allocation of a block of memory of memory 104. The cache is provided on a per physical server basis as opposed to a per virtual machine basis. In a particular embodiment, each user system 142, 144, and 146 connect to VDI 130 over a protected network, such as a corporate wide-area network (WAN), local area network (LAN), intranet, or the like, such that the users have secure access to their respective virtual machines 120, 122, and 124. In another embodiment, each user system 142, 144, and 146 connects to VDI 130 over a public network, such as the Internet, a publicly accessible Wi-Fi network, or the like. Here, virtual desktop manager 114 operates to ensure that user systems 142, 144, and 146 have secure access to their respective virtual machines 132, 134, and 136. For example, virtual desktop manager 114 can operate to provide a virtual private network (VPN) or another secure communication channel to user systems 142, 144, and 146. In this way, the access to each user system to their respective operating system environments and application software is available to the user systems from remote locations and through a wide array of connected devices. In yet another embodiment, each user system 112, 114, and 116 has the option of using a protected network or a public network.

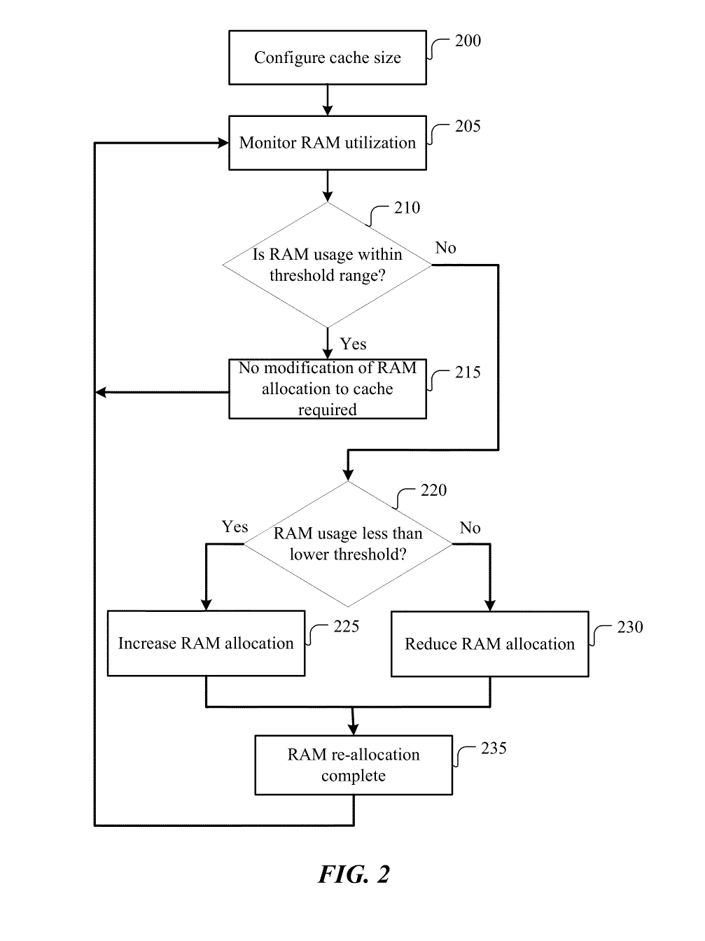

FIG. 2 illustrates a method of optimizing caching to RAM of disk I/O operations in a virtual environment, for example, a VDI environment, thereby reducing the TOPS, beginning at block 200. At block 200, processor 102 configures the cache size or allocates memory to cache according to predetermined criteria. In one embodiment, a hypervisor or VMM 118 allocates the cache. In one embodiment, the cache is a partition of memory 104. In one embodiment, the cache size may be initially configured according to a percentage of available memory in memory 104. In one embodiment, an administrator sets the allocation of cache. Any other technique known to one of ordinary skill in the art may also be used for allocating the initial cache size in VDI 130 for use by the VMM 118. The cache is shared by all the virtual desktops instantiated on user systems 142, 144, and 146. Thus, the cache must be initially set large enough to allow for caching for sufficient disk TOPS to RAM but small enough so as not to impede the efficiency of other processing operations.

At block 205, the information handling system 128 monitors the utilization of memory 104. In certain embodiments, the monitoring may be performed by one or more of the VMM 118, a program (singled-threaded or multi-threaded) executed by the processor 102, a hypervisor, the virtual desktop manager 114, the VDI manager 126, or any other device whether hardware and/or software known to one of ordinary skill in the art. One or more relevant assessment techniques may be implemented to monitor the utilization of memory 104. The relevant assessment techniques allow for dynamic allocation or re-allocation of RAM to cache as these techniques are not based on static information or measurements. Rather, these techniques are based, at least in part, on actual usage of memory 104. In one embodiment, utilization of memory 104 is determined based, at least in part, on rudimentary memory management techniques. Such rudimentary memory management techniques include, for example, reporting the total RAM allocated to each instantiated virtual machine, such as VM-1 120, VM-2 122, and VM-3 124 The VMM 118 or a hypervisor may determine the utilization of memory 104. For example, at the hypervisor level the hypervisor maintains an aggregate total of usage of memory 104 by the user systems 142, 144, and 146 associated with virtual machines VM-1 120, VM-2, VM-3 124, respectively. This total may be used to, at least in part, allocate RAM to cache.

In another embodiment, utilization of memory 104 is based, at least in part, on advanced memory management techniques at the physical server level. For example, RAM usage may be reported by any number of techniques such as VMware active memory, Hyper-V, XenServer, Kernel-based Virtual Machine (KVM), and any other known advanced memory management techniques. Advanced memory management techniques inspect the utilization of memory 104 at a deeper level than other techniques. For example, advanced memory management techniques may determine if RAM that may have been flagged for usage has actually been used or whether it has been used within a specified time interval. An application may appear to require significant amounts of RAM but upon further inspection of actual use of RAM it may be determined that a smaller amount of RAM can service the application without imposing any hits on data access time or processing.

In one embodiment, utilization of memory 104 is calculated based, at least in part, on recording RAM usage by low priority user applications. For example, an administrator may assign certain tasks or applications as having a low priority level while others have a high priority level. For example, music and gaming applications may be categorized as low priority tasks. During monitoring, an inspection may be made of the applications running on each virtual machine. Those tasks and applications with a low priority may have memory pages relating to the low priority tasks, such as music and gaming applications, migrated to a swap file so as to permit greater amounts of cache memory to be allocated for use by the VDI 130.

In one embodiment, monitoring of utilization of memory 104 at block 205, or RAM usage, may be performed as a scheduled task, on-demand, by polling, or any other technique known to one of ordinary skill in the art. The scheduled task may set pre-defined time periods when monitoring is performed. For example, RAM usage may be monitored at a set time interval, for example, every 10 minutes, or every hour, or any other user-defined time interval or interval indicated by a timer. RAM usage may also be monitored at known high-usage, high-memory access time periods. For example, during normal business hours monitoring may be scheduled more frequently as compared to late-night hours when RAM usage is typically low. Monitoring may also be triggered by an alert, semaphore, database entry, entry in a specific storage location, or any other indicator known to one of ordinary skill in the art. For example, when an alert is raised, the RAM usage may be monitored or RAM usage may be measured for a specific point in time. In one embodiment, the RAM usage is monitored for a pre-defined time interval when a pre-defined value is written to a specific memory location, or a database entry is detected, or a flag is set or an alert is raised, etc. In one embodiment, an administrator may initiate monitoring and modification (on-demand). The administrator's initiation may be based, at least in part, on a software and/or hardware indicator such as an LED, an alarm, an email message, or any other software and/or hardware indicator known to one of ordinary skill in the art. The present invention contemplates any known monitoring technique and is not limited by examples described herein.

At block 210, it is determined if the RAM usage is within a threshold range. The threshold range may be pre-defined by a user or administrator. The threshold range may also be determined according to pre-defined criteria. For example, an administrator may set the threshold range based on an “ideal” RAM utilization level that balances the requirement for an element of headroom with the requirement for cost-effective utilization of the RAM resource. The cost-effective utilization of the RAM resource may be determined by historical utilization of the memory. In one embodiment, the lower threshold may approximate 80% of the total available RAM and the upper threshold would approximate 90% of the total available RAM. In other embodiments, the upper and lower threshold values may be set according to system settings each time the information handling system 128 experiences a system change. For example, a system change may include any one or more known alterations to the current state of operation such as reset, reboot, power-up, BIOS setting change, upgrade, installation of software and/or software, or any other system change known to one of ordinary skill in the art.

If RAM usage at block 210 is determined to be within the threshold range, no dynamic modification of RAM allocation to cache is required. If RAM usage at block 210 is not within the threshold range, then it is determined at block 220 if the RAM usage is less than the lower threshold. If the RAM usage is less than the lower threshold then at block 225 the RAM allocation to cache is increased to a level such that total RAM usage is within the threshold range. In one embodiment, the RAM allocation to cache is increased such that total RAM usage is at the midpoint of the threshold range. If the RAM is not less than the lower threshold then the RAM usage is greater than the upper threshold and the RAM allocation to cache is reduced to a level such that total RAM usage is within the threshold range. In one embodiment, the RAM allocation to cache is reduced such that total RAM usage is at the midpoint of the threshold range. Blocks 225 and 230 proceed to block 235 where dynamic RAM re-allocation is completed. The RAM allocation for blocks 225 and 230 are dynamically increased or decreased based, at least in part, on any one or more relevant assessment techniques.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures. For example, while IOPS is a particular significant issue for VDI, the present invention is not limited to VDI and may be applicable to any type of virtual environment.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of optimizing caching in a virtual desktop environment comprising:
configuring a cache for use by one or more virtual machines, wherein the cache is allocated from a memory;
monitoring utilization of the memory based, at least in part, on one or more relevant assessment techniques;
defining an upper threshold;
defining a lower threshold, wherein the upper threshold and the lower threshold define a usage range for the memory;
determining if the utilization of the memory is within the usage range;
increasing the memory allocation to the cache when the utilization of the memory is less than the lower threshold based, at least in part, on the one or more relevant assessment techniques; and
decreasing the memory allocation to the cache when the utilization of the memory is greater than the upper threshold based, at least in part, on the one or more relevant assessment techniques.

2. The method of claim 1, wherein the monitoring is performed by one or more of a virtual machine manager, a hypervisor, or a virtual desktop manager.

3. The method of claim 1, wherein the information handling system is part of a virtual desktop infrastructure environment.

4. The method of claim 1, wherein the one or more relevant assessment techniques comprise at least one of one or more rudimentary memory management techniques, one or more advanced memory management techniques and one or more task prioritization techniques.

5. The method of claim 4, wherein the one or more prioritization techniques migrate memory pages relating to one or more low priority tasks to a swap file.

6. The method of claim 4, wherein the one or more advanced memory techniques determine whether a block memory flagged for usage has actually been used.

7. The method of claim 1, wherein the monitoring is triggered by at least one of a scheduled task, a semaphore, and a timer.

8. The method of claim 1, wherein the upper threshold and the lower threshold are defined by at least one of a ratio of headroom to historical utilization of the memory, a system setting, and a pre-defined percentage of the memory.

9. The method of claim 1, further comprising:
triggering the monitoring based, at least in part, on one or more of an alert, an entry in a database, and an entry in a specific storage location.

10. A non-transitory computer readable medium including code for performing a method, the method comprising:
configuring a cache for use by one or more virtual machines, wherein the cache is allocated from a memory;
monitoring utilization of the memory based, at least in part, on one or more relevant assessment techniques;
defining an upper threshold;
defining a lower threshold, wherein the upper threshold and the lower threshold define a usage range for the memory;
determining if the utilization of the memory is within the usage range;
increasing the memory allocation to the cache when the utilization of the memory is less than the lower threshold based, at least in part, on the one or more relevant assessment techniques; and
decreasing the memory allocation to the cache when the utilization of the memory is greater than the upper threshold based, at least in part, on the one or more relevant assessment techniques.

11. The method of claim 10, wherein the monitored is performed by one or more of a virtual machine manager, a hypervisor, or a virtual desktop manager.

12. The method of claim 10, wherein the information handling system is part of a virtual desktop infrastructure environment.

13. The method of claim 10, wherein the one or more relevant assessment techniques comprise at least one of one or more rudimentary memory management techniques, one or more advanced memory management techniques and one or more prioritization techniques.

14. The method of claim 13, wherein the one or more prioritization techniques migrate memory pages relating to one or more low priority tasks to a swap file.

15. The method of claim 13, wherein the one or more advanced memory techniques determine whether a block memory flagged for usage has actually been used.

16. The method of claim 15, wherein the monitoring is triggered by at least one of a scheduled task, a semaphore, and a timer.

17. The method of claim 15, wherein the upper threshold and the lower threshold are defined by at least one of a ratio of headroom to historical utilization of the memory, a system setting, and a pre-defined percentage of the memory.

18. The method of claim 10, further comprising:
triggering the monitoring based, at least in part, on one or more of an alert, an entry in a database, and an entry in a specific storage location.

19. A virtual desktop infrastructure comprising:
a virtualization host operable to:
launch one or more virtual machines; and
associate the one or more virtual machines with corresponding one or more virtual desktop environment;
a virtual desktop manager;
a virtual desktop infrastructure manager; and
a virtual memory manager operable to:
configure a cache for use by one or more virtual machines, wherein the cache is allocated from a memory;
monitor utilization of the memory based, at least in part, on one or more relevant assessment techniques;
define an upper threshold;
define a lower threshold, wherein the upper threshold and the lower threshold define a usage range for the memory;
determine if the utilization of the memory is within the usage range;
increase the memory allocation to the cache when the utilization of the memory is less than the lower threshold based, at least in part, on the one or more relevant assessment techniques; and
decrease the memory allocation to the cache when the utilization of the memory is greater than the upper threshold based, at least in part, on the one or more relevant assessment techniques.

20. The virtual desktop infrastructure of claim 19, wherein the one or more relevant assessment techniques comprise at least one of one or more rudimentary memory management techniques, one or more advanced memory management techniques and one or more task prioritization techniques.
